(19) United States
(12) Patent Application Publication
(10) Pub. No.: US 2023/0298803 A1
(43) Pub. Date: Sep. 21, 2023

(54) ELECTRONIC PART AND METHOD OF MANUFACTURING THE SAME

(71) Applicant: Alps Alpine Co., Ltd., Tokyo (JP)

(72) Inventors: Taishi NUMATA, Niigata-ken (JP); Kazuya KANEKO, Niigata-ken (JP)

(21) Appl. No.: 18/174,448

(22) Filed: Feb. 24, 2023

(30) Foreign Application Priority Data
Mar. 15, 2022 (JP) 2022-040644

(51) Int. Cl. H01F 27/28; H01F 27/29; H01F 27/24; H01F 41/02; H01F 41/04

(52) U.S. Cl. CPC H01F 27/2804; H01F 27/292; H01F 27/24; H01F 41/0206; H01F 41/041; H01F 2027/2809

(57) ABSTRACT

An electronic part has: a conductive unit that has a terminal including a conductor-exposed portion; n insulating unit in contact with the conductive unit, the insulating unit enclosing part of the conductive unit; and a terminal conductive layer in contact with the insulative unit and conductor-exposed portion. The conductive unit is an electricity-conducting body. The insulating unit includes an electric insulator. The conductor-exposed portion is part of the surface of the conductive unit. The terminal conductive layer has: a first conductive layer including conductive particles and a resin; and a second conductive layer formed from a metal having a lower specific resistance than the first conductive layer, the second conductive layer being in contact with the first conductive layer. The first conductive layer and the second conductive layer are in contact with the conductor-exposed portion.

### CLAIM OF PRIORITY

This application claims benefit of Japanese Patent Application No. 2022-040644 filed on Mar. 15, 2022 hereby incorporated by reference.

### BACKGROUND OF THE INVENTION

### 1. Field of the Invention

The present invention relates to an electronic part and the method of manufacturing the electronic part.

### 2. Description of the Related Art

In the field of electronic parts such as inductance elements, there has been a demand for reducing electric power consumed by an electronic part and the amount of heat generated by it from the viewpoint of energy conservation and thermal design. An inductance element in which a coil is embedded in a magnetic core is disclosed in, for example, Japanese Patent No. 6321950, Japanese Registered Utility Model No. 3198412, and Japanese Patent No. 5874134.

In the inductance elements described in Japanese Patent No. 6321950, Japanese Registered Utility Model No. 3198412, and Japanese Patent No. 5874134, a conductive band-shaped body with an insulating coating is wound to form a coil. An end, extending from the coil in a magnetic core, of the band-shaped body is placed on the outer surface of the magnetic core to form a terminal. A paste is applied to the outer surface of the magnetic core so as to cover the terminal. A conductive layer formed from this conductive paste is in contact with a band-shaped exposed portion, which is a conductor exposed through a hole formed in the insulating coating of the terminal. Thus, the conductive layer and terminal are connected to each other so as to create continuity.

A coil part is disclosed in Japanese Unexamined Patent Application Publication No. 2000-306757. The coil part has a core composed of a cylinder and a flange, and also has a coil (winding) formed around the cylinder of the core, With the core part, a conductive paste layer is formed so as to cover a winding end extending from the coil to the flange of the core. A meal-plated layer s formed on the conductive paste layer.

In general, the amount of electric power consumed by an electronic part and the amount of heat generated by it are large at a main portion such as the coil of an inductance element or a flat electrode of a capacitor element. When energy consumed by an electronic part is to be reduced or thermal design is to be eased, therefore, attention is often paid to reduction in the power consumption of a main part or to the amount of its heat generation. Almost no attention has been paid to reduction in the power consumption of a terminal or the amount of its heat generation. Recently, however, more reduction in the electric resistance of a terminal has begun to be demanded from the viewpoint of energy conservation and thermal design.

The present invention addresses the above situation by providing an electronic part in which the electric resistance of a terminal is smaller and a method of manufacturing the electronic part.

### SUMMARY OF THE INVENTION

An electronic part in an aspect of the present invention has: a conductive unit that has a terminal including a conductor-exposed portion; an insulating unit in contact with the conductive unit, the insulating unit enclosing part of the conductive unit; and a terminal conductive layer in contact with the insulative unit and the conductor-exposed portion. The conductive unit is an electricity-conducting body. The insulating unit includes an electric insulator. The conductor-exposed portion is part of the surface of the conductive unit. The terminal conductive layer has: a first conductive layer including conductive particles and a resin; and a second conductive layer formed from a metal having a lower specific resistance than the first conductive layer, the second conductive layer being in contact with the first conductive layer. The first conductive layer and the second conductive layer are in contact with the conductor-exposed portion.

With the electronic part described in (1) above, the first conductive layer may have a first edge enclosed by the first conductive layer; the second conductive layer may be in contact with the conductor-exposed portion through a first space enclosed by the first edge; and an area over which the second conductive layer is in contact with the conductor-exposed portion may be 50% or more of an area over which the first space is in contact with the conductive unit and the insulating unit.

With the electronic part described in (1) or (2) above, the insulating unit may have a second edge enclosed by the insulating unit: and the first conductive layer may be in contact with the conductor-exposed portion and the second edge along the whole of a closed line drawn by the second edge.

With the electronic part described in (1) above, the first conductive layer may have a first edge enclosed by the first conductive layer; the insulating unit may have a second edge enclosed by the insulating unit; the first conductive layer may be in contact with the conductor-exposed portion and the second edge along the whole of a second closed line drawn by the second edge; the second conductive layer may be in contact with the conductor-exposed portion and the first edge along the whole of a first closed line drawn by the first edge; and an area over which the second conductive layer is in contact with the conductor-exposed portion may be 50% or more of the area of the conductor-exposed portion.

With the electronic part described in any one of (1) to (4) above, an area over which the second conductive layer is in contact with the conductor-exposed portion may be larger than an area over which the second conductive layer is in contact with the edge of the first conductive layer.

With the electronic part described in any one of (1) to (5) above, the insulating unit may have a layer including a resin; and the layer may be in contact with the conductive unit.

With the electronic part described in (3) or (4) above, the insulating unit may have a layer formed from a resin; the layer may be in contact with the conductive unit; and the layer may have the second edge.

With the electronic part described in any one of (1) to (7) above, the conductive unit may be formed from one type of metal.

With the electronic part described in any one of (1) to (8) above, the ratio of the areas of the conductive particles to the cross-sectional area of the first conductive layer may be 10% or more and 90% or less.

A method, in an aspect of the present invention, of manufacturing an electronic part includes: a coating step of forming a first conductive layer by applying a conductive paste including conductive particles and a resin to the surface of an electricity-conducting body and to the surface of an electric insulator so as to connect the electricity-conducting body and the electric insulator together; an exposure step of forming an opening in the first conductive layer so as to expose the electricity-conducting body to a surface; a curing step of curing the first conductive layer; and a plating step of forming a second conductive layer by plating the electricity-conducting body and the first conductive layer with a metal having a lower specific resistance than the first conductive layer so as to connect the electricity-conducting body and the first conductive layer together through the opening.

In the exposure step in the method, described in (10) above, of manufacturing an electronic part, part of the first conductive layer may be removed to form the opening.

According to the above aspect of the present invention, it is possible to provide an electronic part in which the electric resistance of a terminal is smaller and a method of manufacturing the electronic part.

### BRIEF DESCRIPTION OF THE DRAWINGS

FIG. 1 is a perspective view illustrating an example of an inductance element according to an embodiment of the present invention;

FIG. 2 is a bottom view of the inductance element in FIG. 1;

FIG. 3 is a longitudinal sectional view illustrating an example of the cross section of the inductance element in FIG. 1 as taken along line III-III;

FIG. 4 is a longitudinal sectional view illustrating an example of the terminal structure of the inductance element in this embodiment;

FIG. 5 is a longitudinal sectional view illustrating an example of the terminal structure of the inductance element in FIG. 4 as taken along line V-V;

FIG. 6 illustrates an example of a conductor-exposed portion formed in the terminal of the inductance element in this embodiment;

FIG. 7 is a longitudinal sectional view to explain the terminal resistance of the inductance element in this embodiment;

FIG. 8A illustrates an example of a first region in a terminal conductive layer in this embodiment;

FIG. 8B illustrates an example of a second region in the terminal conductive layer in this embodiment;

FIG. 9 illustrates an example of a positional relationship between an opening and the conductor-exposed portion in the inductance element in this embodiment when part of the edge of the opening is not in contact with the conductor-exposed portion;

FIG. 10 is a longitudinal sectional view illustrating an example of the cross section of the inductance element in FIG. 9 as taken along line X-X;

FIG. 11 illustrates an example of a relationship between the conductive connection ratio and terminal resistance in the inductance element in this embodiment;

FIG. 12 is a flowchart illustrating a method, in an embodiment of the present invention, of manufacturing the inductance element;

FIG. 13 illustrates longitudinal cross sections indicating a specific example of the method, in this embodiment, of manufacturing the inductance element:

FIG. 14 is a longitudinal sectional view illustrating an example of an inductance element in variation 1 in this embodiment;

FIG. 15 is a bottom view illustrating an inductance element in variation 2 in this embodiment; and

FIG. 16 is a longitudinal sectional view illustrating an inductance element in variation 3 in this embodiment.

### DESCRIPTION OF THE PREFERRED EMBODIMENTS

Preferred embodiments of an electronic part in the present invention and a method of manufacturing the electronic part will be described below with reference to the attached drawings. The present invention is not limited by the embodiments below. The drawings just illustrate schematic examples. Dimensional relationships among elements in the drawings, the ratios of the dimensions of elements, and other dimensional conditions may differ from actual products. Dimensional relationships of elements and the ratios of the dimensions of elements may also differ among the drawings. In the drawings, substantially the same elements are assigned the same reference characters.

### Electronic Part

First, an electronic part in an embodiment of the present invention will be described. In the description below, an inductance element will be taken as an example of the electronic part in the present invention. The inductance element will be described below in detail.

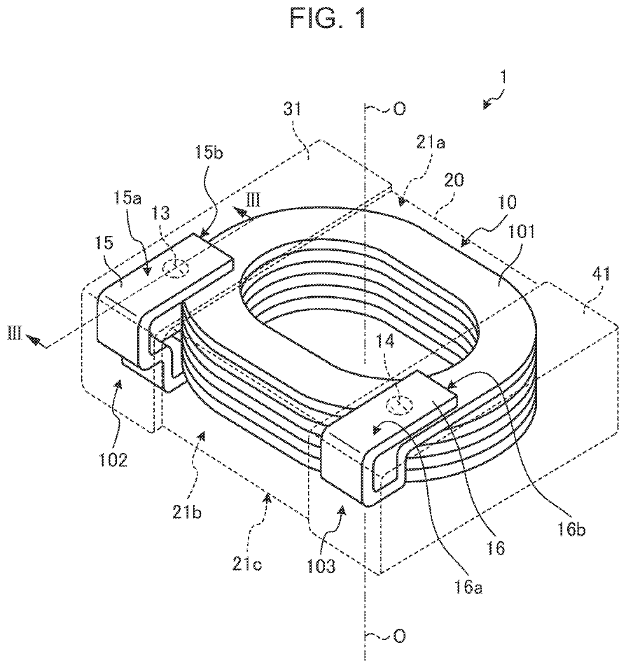

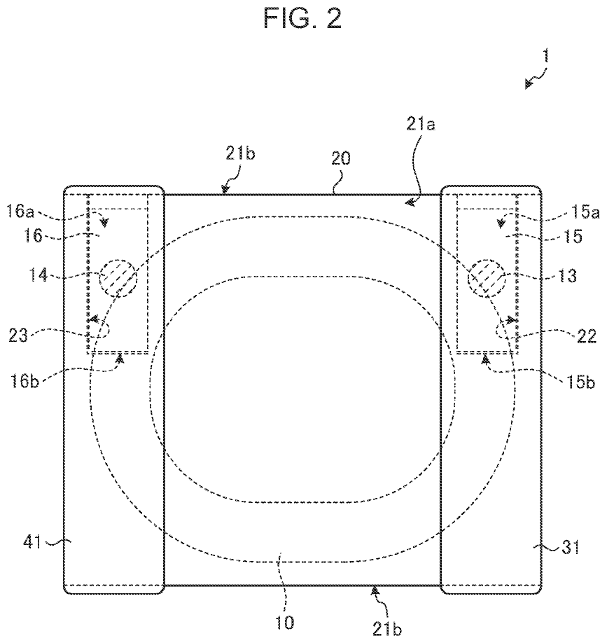

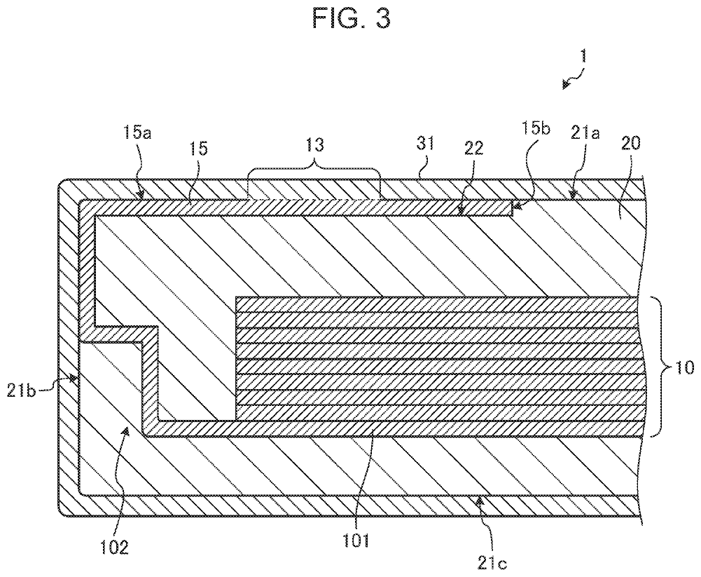

FIG. 1 is a perspective view illustrating an example of an inductance element according to this embodiment of the present invention. FIG. 2 is a bottom view of the inductance element in FIG. 1. FIG. 3 is a longitudinal sectional view illustrating an example of the cross section of the inductance element in FIG. 1 as taken along line III-III (the cross section that is perpendicular to the direction indicated by the arrows and is taken along line III-III). The inductance element 1 in this embodiment has a coil 10, a magnetic core 20 that internally includes part of the coil 10, and terminal conductive layers 31 and 41 in contact with the coil 10, as illustrated in FIGS. 1 to 3. Terminals (first terminal 15 and second terminal 16) of the coil 10 are placed on a lower surface 21a of the magnetic core 20.

In FIG. 1, the inductance element 1 is illustrated so that the lower surface 21a of the magnetic core 20 is oriented toward the upper side of the drawing sheet for convenience of explanation. In FIG. 1, the coil 10 is illustrated by solid lines and the magnetic core 20 is illustrated by dotted lines.

As illustrated in FIG. 1, the coil 10 has a ring-shaped portion 101, which is a functional portion, a pair of terminals (first terminal 15 and second terminal 16), and a pair of connection portions 102 and 103, which connect the ring-shaped portion 101 and the pair of terminals together. The pair of terminals are formed in the form of, for example, the ends of a conductive band-shaped body. The ring-shaped portion 101 is formed by, for example, winding a portion of the conductive band-shaped body, the portion being other than the ends of a conductive band-shaped body, around the central axis O. In this way, the ring-shaped portion 101 and the pair of terminals may be formed from a single continuous material. As will be described below, the band-shaped body in this embodiment is a band-shaped conductor with an insulating coating. That is, the coil 10 has a conductor, which is equivalent to a conductor 11 described below, and an insulating coating, which is equivalent to an insulating coating 12 described below, in contact with this conductor.

The first terminal 15 and second terminal 16 are placed with a predetermined spacing in the width direction of the magnetic core 20 (in the left and right direction of the drawing sheet in FIG. 2). The first terminal 15 and second terminal 16 are formed by, for example, bending both ends of a band-shaped body in the longitudinal direction at least once, as illustrated in FIGS. 1 and 2. One of the first terminal 15 and second terminal 16 is an input terminal, and the other is an output terminal. In this embodiment, when a current flows from the input terminal to the output terminal, a magnetic flux is generated in a region enclosed by the ring-shaped portion 101, the region including the central axis O. The magnetic core 20 forms a path of the magnetic flux.

Specifically, the first terminal 15 is bent so that it extends along the lower surface 21a from the side surface 21b of the magnetic core 20, and is seated in a recess 22 formed in the lower surface 21a of the magnetic core 20, as illustrated in FIGS. 1 to 3. The terminal surface 15a of the first terminal 15 is present in substantially the same plane as the plane of the lower surface 21a of the magnetic core 20, and is exposed from the magnetic core 20 to the surface of the magnetic core 20. The end surface 15b of the first terminal 15 is in contact with the side wall surface of the recess 22. In the vicinity of the first terminal 15, part of the connection portion 102 is placed so as to form a plane that is substantially the same as the plane of the side surface 21b of the magnetic core 20, as illustrated in FIGS. 1 and 3.

As with the first terminal 15 described above, the second terminal 16 is bent so that it extends along the lower surface 21a from the side surface 21b and is seated in a recess 23 formed in the lower surface 21a of the magnetic core 20, as illustrated in FIGS. 1 and 2. The terminal surface 16a of the second terminal 16 is present in substantially the same plane as the plane of the lower surface 21a of the magnetic core 20, and is exposed from the magnetic core 20 to the surface of the magnetic core 20. The end surface 16b of the second terminal 16 is in contact with the side wall surface of the recess 23. In the vicinity of the second terminal 16, part of the connection portion 103 is placed so as to form a plane that is substantially the same as the plane of the side surfaces 21b of the magnetic core 20.

The first terminal 15 has a conductor-exposed portion 13 and the second terminal 16 has a conductor-exposed portion 14, as illustrated in FIGS. 1 to 3. Each of the conductor-exposed portions 13 and 14 is a portion of the band-shaped body, at which the insulating coating, which is an electric insulator, is not present on the surface of the band-shaped body, that is, the surface of an electricity-conducting body, and the conductor is thereby exposed. The conductor-exposed portion 13 is part of the terminal surface 15a of the first terminal 15. The conductor-exposed portion 14 is part of the terminal surface 16a of the second terminal 16.

The magnetic core 20 is an example of an insulating unit in this embodiment. The magnetic core 20 encloses and holds the whole of the ring-shaped portion 101 of the coil 10 and part of the connection portions 102 and 103, as illustrated in FIGS. 1 to 3. Specifically, the magnetic core 20 is a molded body including magnetic powder and a resin that functions as a binder. The shape of the magnetic core 20 is, for example, a rectangular parallelepiped or cube, as illustrated in FIG. 1. The ring-shaped portion 101 of the coil 10 is embedded in the magnetic core 20, as illustrated in FIGS. 1 and 2. The first terminal 15 and second terminal 16 of the coil 10 are respectively fitted to the recesses 22 and 23 in the lower surface 21a of the magnetic core 20.

The terminal conductive layers 31 and 41 are placed with a predetermined spacing in the width direction of the magnetic core 20, and are in contact with the surfaces of the coil 10 and magnetic core 20, as illustrated in FIGS. 1 and 2. Therefore, the terminal conductive layer 31 is electrically connected to the first terminal 15 of the coil 10. Similarly, the terminal conductive layer 41 is electrically connected to the second terminal 16. However, the terminal conductive layer 31 and terminal conductive layer 41 are not in contact with each other.

Specifically, the terminal conductive layer 31 is in contact with the surfaces of the first terminal 15 and magnetic core 20. As long as, for example, the terminal conductive layer 31 is not in contact with either of the second terminal 16 and terminal conductive layer 41, that is, is separated from them, as illustrated in FIGS. 1 and 2, the terminal conductive layer 31 may be in contact with not only the first terminal 15 and lower surface 21a but also at least one of the side surfaces 21b and an upper surface 21c. The terminal conductive layer 31 is also in contact with the conductor-exposed portion 13, as illustrated in FIG. 3. Therefore, the terminal conductive layer 31 is electrically connected to the first terminal 15.

Similarly, the terminal conductive layer 41 is in contact with the surfaces of the second terminal 16 and magnetic core 20. As long as, for example, the terminal conductive layer 41 is not in contact with either of the first terminal 15 and terminal conductive layer 31, that is, is separated from them, the terminal conductive layer 41 may be in contact with not only the second terminal 16 and lower surface 21a but also at least one of the side surfaces 21b and upper surface 21c. The terminal conductive layer 41 is also in contact with the conductor-exposed portion 14. Therefore, the terminal conductive layer 41 is electrically connected to the second terminal 16.

### <Terminal Structure>

Next, the terminal structure of the inductance element 1 in this embodiment will be described. The terminal structure of the inductance element 1 establishes an electrical connection between the coil 10 and the terminal conductive layers 31 and 41.

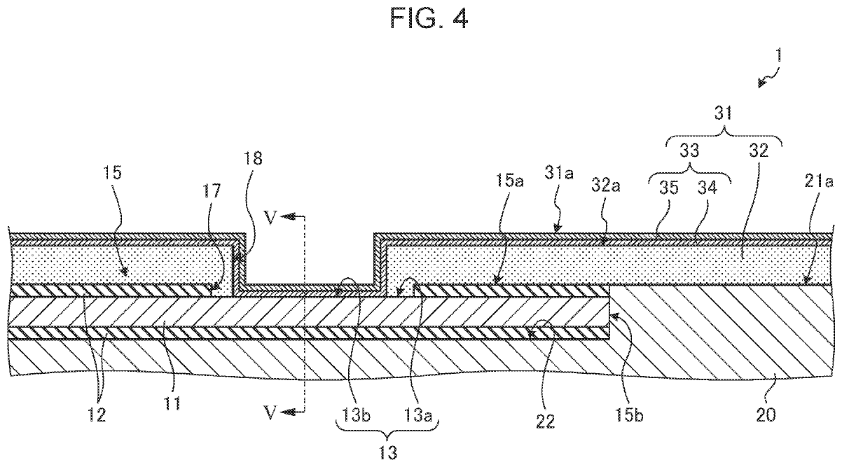

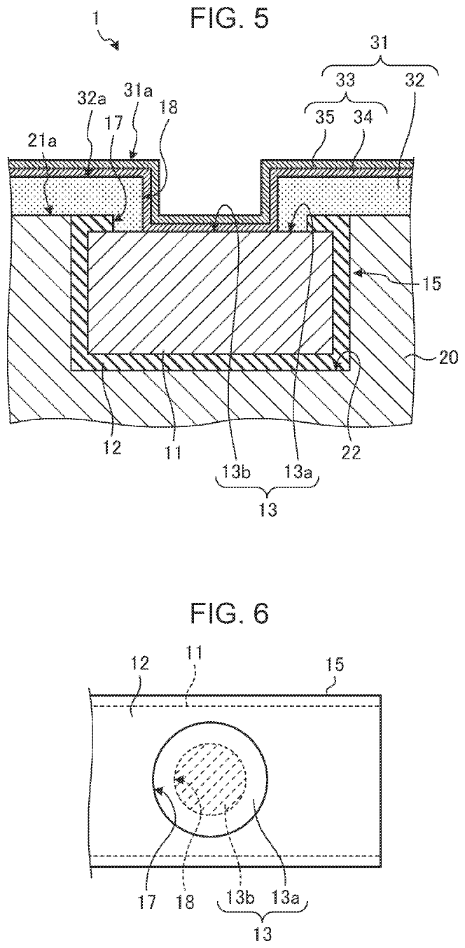

FIG. 4 is a longitudinal sectional view illustrating an example of the terminal structure of the inductance element 1 in this embodiment. FIG. 5 is a longitudinal sectional view illustrating an example of the terminal structure of the inductance element 1 in FIG. 4 as taken along line V-V (the cross section that is perpendicular to the direction indicated by the arrows and is taken along line V-V). FIG. 6 illustrates an example of the conductor-exposed portion 13 formed in the first terminal 15 of the inductance element 1 in this embodiment.

As illustrated in FIGS. 4 and 5, the first terminal 15 has a conductor 11, which is an electricity-conducting body, and an insulating coating 12, which is an electric insulator, the insulating coating 12 being in contact with the conductor 11. The conductor 11 is an example of a conductive unit in this embodiment. The conductor 11 is formed from a material having a low specific resistance of, for example, higher than or equal to 1.0×10⁻⁸ Ωm and lower than or equal to 1.0×10⁻⁶ Ωm at 20° C. The material of the conductor 11 is, for example, a pure metal such as copper, aluminum, nickel or iron, an alloy such as brass or stainless steel, or a composite metal such as copper-clad aluminum. In consideration of electric conductivity and a cost, the conductor 11 is preferably formed from copper. To reduce contact resistance, the conductor 11 is preferably continuous without seams. The conductor 11 is a metal wire having, for example, a rectangular transverse cross section, which is a cross section perpendicular to the direction in which the conductor 11 extends, as illustrated in FIG. 5. The conductor 11 has a thickness of greater than or equal to 0.01 mm and smaller than or equal to 0.8 mm. A current can flow from the first terminal 15 through the conductor 11 toward the second terminal 16.

The insulating coating 12 is an example of the insulating unit in this embodiment. The insulating coating 12 is formed from a material having a high specific resistance of, for example, higher than or equal to 1.0×10⁴ Ωm and lower than or equal to 1.0×10²⁰ Ωm at 20° C. The material of the insulating coating 12 is, for example, an organic material (polymer) such as polyvinylchloride, polyimide or polyurethane or an inorganic material such as alumina, silica or magnesia. To make the electric insulation property more reliable, the insulating coating 12 is preferably continuous without seams. The insulating coating 12 may have a plurality of layers so as to implement a plurality of functions. The insulating coating 12 may include, for example, a first insulative layer in contact with the surface of the conductor 11 and a second insulative layer in contact with the first insulative layer. To enhance an intimate contact between the coil 10 and the magnetic core 20, the topmost surface of the insulating coating 12 may be formed from, for example, nylon. The insulating coating 12 insulates the conductor 11 to prevent it from being electrically connected to other materials in a direction perpendicular to the direction in which the conductor 11 extends, the other materials excluding the first terminal 15 and second terminal 16.

A hole 17 is formed in the insulating coating 12 so that the conductor 11 (specifically, the conductor-exposed portion 13) is exposed to the terminal surface 15a, as illustrated in FIGS. 4 and 5. That is, the conductor-exposed portion 13 is part of the conductor 11, the part being exposed to the terminal surface 15a through the hole 17. The hole 17 is shaped like a circle in plan view, as illustrated in FIG. 6. Due to the hole 17, a recess is formed in the terminal surface 15a and the conductor-exposed portion 13 is formed on the bottom of the recess (see FIGS. 4 and 5). The terminal surface 15a is not in contact with the magnetic core 20 but is in contact with the terminal conductive layer 31.

The insulating coating 12 is not present at the end surface 15b of the first terminal 15, as illustrated in FIG. 4. This is because the end surface 15b corresponds to a cross section formed when the band-shaped body is cut. The end surface 15b of this type is in contact with the side wall surfaces of the recess 22 in the magnetic core 20, as illustrated in FIG. 4.

The terminal conductive layer 31 is in contact with the conductor-exposed portion 13, as illustrated in FIGS. 4 and 5. The terminal conductive layer 31 has a first conductive layer 32 and a second conductive layer 33, which has a lower specific resistance than the first conductive layer 32, as illustrated in FIGS. 4 and 5.

The first conductive layer 32 includes particles of a conductive material and a resin (polymer). Particles of the conductive material may be metal particles or carbon (C) particles. The first conductive layer 32 is, for example, a layer including metal particles and a resin. Metal particles are, for example, sliver (Ag), copper (Cu), or nickel (Ni) particles. The resin is, for example, an epoxy resin that functions as a binder. The material of the first conductive layer 32 may be a conductive paste or a layer, such as, for example, a thermally cured layer, derived from this conductive layer. An example of this conductive paste is a silver paste. The amount of particles of conductive material included in the first conductive layer 32 can be defined by, for example, the ratio of the area of the particles of the conductive material to the area of the first conductive layer 32 in a microscopic image of the cross section of the first conductive layer 32. In this case, the amount of conductive particles is, for example, more than or equal to 10% and less than or equal to 90%. When the amount is more than or equal to 10%, the conductive path formed by particles of the conductive material becomes large, enabling the specific resistance to be adequately lowered. When the amount is at less than or equal to 90%, the resin in the first conductive layer 32 and the resin in the magnetic core 20 come into contact with each other in an adequately large area, achieving an intimate contact between the first conductive layer 32 and the magnetic core 20 to be enhanced.

The first conductive layer 32 is in contact with the terminal surface 15a and the surface of the magnetic core 20 (the surface is the lower surface 21a in FIGS. 1 to 3), as illustrated in FIGS. 4 and 5. The first conductive layer 32 is also in contact with a first exposed region 13a, which is part of the conductor-exposed portion 13. The first exposed region 13a is present along the circumferential edge of the conductor-exposed portion 13, as illustrated in FIGS. 4 to 6. Thus, the first conductive layer 32 is electrically connected to the conductor-exposed portion 13. The first conductive layer 32 may be formed from particles of a conductive material and a resin (polymer). The specific resistance of the first conductive layer 32 may be, for example, higher than or equal to 5.0×10⁻⁸ Ωm and lower than or equal to 1.0×10⁻⁵ Ωm at 20° C.

The second conductive layer 33 is a layer of a metal having a lower specific resistance than the first conductive layer 32. The specific resistance of the second conductive layer 33 is, for example, higher than or equal to 1.0×10⁻⁸ Ωm and lower than or equal to 1.0×10⁻⁶ Ωm at 20° C. The metal is, for example, nickel (Ni), tin (Sn), or copper (Cu). The second conductive layer 33 may be a metal-plated layer. The second conductive layer 33 is present along the surface of the first conductive layer 32, as illustrated in FIGS. 4 and 5. The second conductive layer 33 is in contact with the first conductive layer 32 and with a second exposed region 13b, which is part of the conductor-exposed portion 13. The second exposed region 13b is a different region from the first exposed region 13a, as illustrated in FIGS. 4 to 6. That is, the second exposed region 13b is a remaining region resulting from excluding the first exposed region 13a from the conductor-exposed portion 13.

Specifically, an opening 18 is formed in the first conductive layer 32 described above so that the conductor 11 (specifically, the conductor-exposed portion 13) is exposed to the surface, as illustrated in FIGS. 4 and 5. That is, the second exposed region 13b is part of the conductor-exposed portion 13, the part being exposed to the surface through the opening 18, as illustrated in FIG. 6. Due to the opening 18, a recess is formed in an intermediate surface 32a formed by the first conductive layer 32 and first terminal 15 and the second exposed region 13b is formed on the bottom of the recess. The second conductive layer 33 is in contact with the second exposed region 13b through the opening 18 in the first conductive layer 32. Thus, the second conductive layer 33 is electrically connected to the conductor-exposed portion 13.

To reduce the cost of the second conductive layer 33, the ratio of the thickness of the second conductive layer 33 to the thickness of the first conductive layer 32 may be greater than or equal to 0.01 and smaller than or equal to 0.60. In this case, to reduce the electric resistances of the first terminal 15 and second terminal 16, the ratio of the specific resistance of the second conductive layer 33 to the specific resistance of the first conductive layer 32 is preferably higher than or equal to 0 and lower than or equal to 0.60. When each of the first conductive layer 32 and second conductive layer 33 composed of a plurality of layers, the specific resistance is given as parallel resistance. To reduce the electric resistance of the first terminal 15 and second terminal 16, the ratio of the thickness of the second conductive layer 33 to the thickness of the first conductive layer 32 may be greater than 0.60 and smaller than or equal to 10.

The second conductive layer 33 may be a single layer or may be a plurality of layers. For example, the second conductive layer 33 has a first metal layer 34 and a second metal layer 35, as illustrated in FIGS. 4 and 5.

The first metal layer 34 is a metal layer formed from nickel or the like. The first metal layer 34 is in contact with the first conductive layer 32 and second exposed region 13b, as illustrated in FIGS. 4 and 5. That is, the first metal layer 34 is in contact with the second exposed region 13b and the upper surface and side surface of the first conductive layer 32. The first metal layer 34 is preferably in contact with the whole of the second exposed region 13b and the whole of the side surface of the first conductive layer 32, for example. Also, the first metal layer 34 is preferably in contact with the whole of the upper surface of the first conductive layer 32, for example. The upper surface of the first conductive layer 32 is one of the two surfaces, of the first conductive layer 32, perpendicular to the thickness direction, that is, a pair of surfaces that define the thickness of the first conductive layer 32, the one surface being opposite to the terminal surface 15a. The side surface of the first conductive layer 32 is the inner wall surface (first edge) of the opening 18. As a result, the first metal layer 34 is electrically connected to the conductor-exposed portion 13.

The second metal layer 35 is a metal layer formed from tin or the like. The second metal layer 35 differs from the first metal layer 34 in composition or tissue. The second metal layer 35 is in contact with the first metal layer 34, as illustrated in FIGS. 4 and 5. For example, the second metal layer 35 is in contact with the whole of the upper surface of the first metal layer 34. The upper surface of the first metal layer 34 is one of the two surfaces, of the first metal layer 34, perpendicular to the thickness direction, that is, a pair of surfaces that define the thickness of the first metal layer 34, the one surface being opposite to the first conductive layer 32 and second exposed region 13b. As a result, the second metal layer 35 is electrically connected to the first conductive layer 32 and conductor-exposed portion 13 through the first metal layer 34.

Therefore, the second conductive layer 33 is in contact with the conductor 11 and first conductive layer 32 so as to pass over the first edge. The first conductive layer 32 is in contact with the conductor 11 and insulating unit so as to pass over a second edge, which is the circumferential edge of the hole 17. As a result, the terminal conductive layer 31 and conductor 11 can be electrically connected to each other while a force with which the terminal conductive layer 31 and coil 10 are brought into intimate contact with each other is secured.

To reduce the electric resistance of the terminal conductive layer 31, the area of the second exposed region 13b is preferably 50% or more of the area of the conductor-exposed portion 13. The whole of the second exposed region 13b is particularly preferably is enclosed by the first exposed region 13a, as illustrated in FIG. 6. That is, the first conductive layer 32 is particularly preferably in contact with the first exposed region 13a over the entire circumference of the circumferential edge (second edge) of the hole 17, as illustrated in FIGS. 4 and 5. In this case, the first exposed region 13a encloses the second exposed region 13b over the entire circumference of the circumferential edge of the hole 17. That is, the second conductive layer 33 is particularly preferably in contact with the entire surface of the second exposed region 13b enclosed by the first conductive layer 32.

To reduce the electric resistance of the terminal conductive layer 31 and to enhance an intimate contact between the first terminal 15 and the terminal conductive layer 31, the contact area between the second conductive layer 33 and the conductor-exposed portion 13 is preferably larger than the contact area between the second conductive layer 33 and the side surface of the first conductive layer 32. For example, the contact area between the second conductive layer 33 and the conductor-exposed portion 13 is the contact area between the first metal layer 34 and the second exposed region 13b. The contact area between the second conductive layer 33 and the side surface of the first conductive layer 32 is the contact area between the first metal layer 34 and the inner wall surface (side surface) of the opening 18 in the first conductive layer 32.

Although not illustrated, the second terminal 16 and terminal conductive layer 41 are respectively similar to the first terminal 15 and terminal conductive layer 31 described above. That is, the second terminal 16 and terminal conductive layer 41 respectively have a cross section similar to the cross section of the first terminal 15 and terminal conductive layer 31 illustrated in FIGS. 4 and 5. Furthermore, the second terminal 16 has the conductor-exposed portion 14 similar to the conductor-exposed portion 13 illustrated in FIG. 6. The connection portions 102 and 103 have a cross section similar to the cross section of the conductor 11 and insulating coating 12 on the same side as the first terminal 15 described above, except that the connection portion 102 lacks the conductor-exposed portion 13 and that the connection portion 103 lacks the conductor-exposed portion 14.

### <Electric Resistance of the Terminal>

Next, the electric resistance of the terminal of the inductance element 1 in this embodiment will be described (the electric resistance will be referred to below as the terminal resistance). The terminal resistance of the inductance element 1 is the electric resistance of the terminal conductive layers 31 and 41.

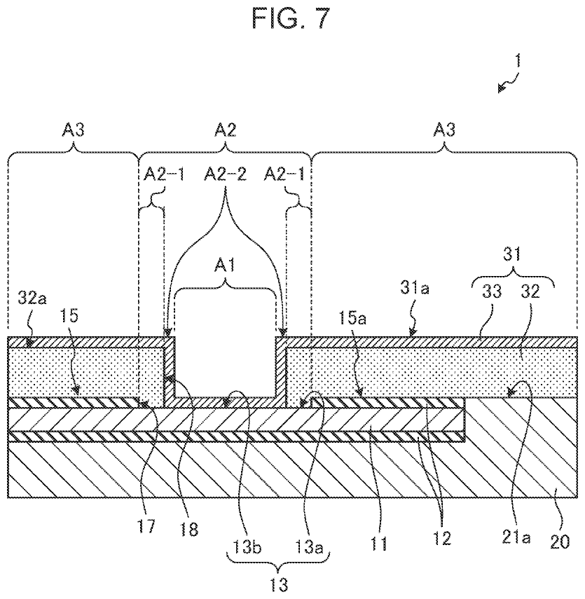

FIG. 7 is a longitudinal sectional view to explain the terminal resistance of the inductance element 1 in this embodiment. As illustrated in FIG. 7, the terminal conductive layer 31 is formed on the lower surface 21a of the magnetic core 20 so as to cover the terminal surface 15a of the first terminal 15. Since the terminal conductive layer 31 is in contact with the conductor-exposed portion 13, which is part of the conductor 11 on the same side as the first terminal 15, the part being exposed from the insulating coating 12, the terminal conductive layer 31 is electrically connected to the first terminal 15. The terminal resistance of the terminal conductive layer 31 is approximately the sum of the electric resistance rₐ of a first region A1, the electric resistance r_{b} of a second region A2, and the electric resistance r_{c} of a third region A3, the sum being a series resistance. The first region A1, second region A2, and third region A3 are three parts into which the terminal conductive layer 31 is divided along planes, indicated by the dotted lines in FIG. 7, orthogonal to the opening plane (that is, the second exposed region 13b) of the opening 18.

Specifically, as illustrated in FIG. 7, the first region A1 is part of the terminal conductive layer 31, the part being enclosed by a plane A extending from the side wall surface of the recess formed in a conductive layer surface 31a in a direction along the side wall surface. In the sectional view, the first region A1 is a portion between planes. The first region A1 is in contact with part of the second exposed region 13b. The second region A2 is also part of the terminal conductive layer 31, the part being enclosed by the plane A and a plane B extending from the side wall surface of the recess formed in the terminal surface 15a in a direction along the side wall surface. The second region A2 includes a low-conductivity region A2-1 and a high-conductivity region A2-2. The low-conductivity region A2-1 is part of the terminal conductive layer 31, the part being enclosed by the plane B and a plane C extending from the side wall surface of the recess formed in the intermediate surface 32a in a direction along the side wall surface. The low-conductivity region A2-1 is in contact with the entire surface of the first exposed region 13a. The high-conductivity region A2-2 is also part of the terminal conductive layer 31, the part being enclosed by the planes A and plane C. The third region A3 is a remaining region resulting from excluding the first region A1 and second region A2 from the entire region of the terminal conductive layer 31. The third region A3 is in contact with the insulating coating 12 and lower surface 21a.

In general, electric resistance r is given by equation (1) below, in which ρ is the resistivity of the material, L is the length of the material, and S is the area of the material. The length L of the material is measured in the main direction in which a current flows. The area S of the material is the area of the cross section perpendicular to the main direction in which a current flows. In the calculation of the terminal resistance of the terminal conductive layer 31, therefore, the length L of the material is the length in a direction (upward direction of the drawing sheet in FIG. 7) perpendicular to the surface of the conductor-exposed portion 13 in FIG. 7, the surface being an exposed surface.

$$r = ρ \frac{L}{S} \qquad ( 1 )$$

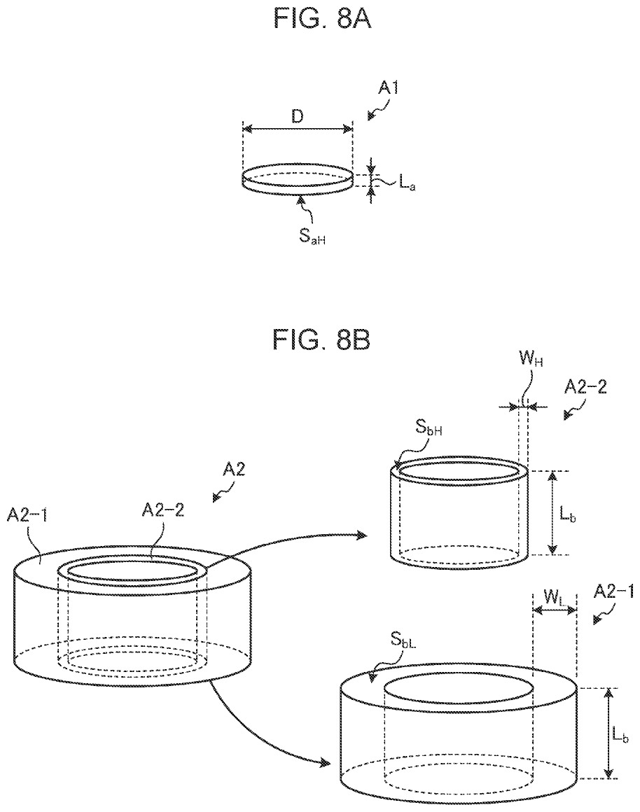

The electric resistance rₐ of the first region A1 is calculated on the basis of the illustration in FIG. 8A. FIG. 8A illustrates an example of the first region A1 in this embodiment. As illustrated in FIG. 8A, the first region A1 is, for example, discoidal. The bottom surface of the first region A1 is in contact with the second exposed region 13b. In the first region A1, the length La is equivalent to the thickness of the second conductive layer 33, and the area S_{aH} is equivalent to the area of the bottom surface of the first region A1. The electric resistance rₐ is given by equation (2) below, in which La is the length, S_{aH} is the area, and pH is the resistivity of the second conductive layer 33.

$${r}_{a} = {ρ}_{H} \frac{{L}_{a}}{{S}_{a H}} \qquad ( 2 )$$

The area S_{aH} is given by equation (3) below, in which the diameter of the first region A1 in a discoidal shape is used. The diameter D of the opening 18 will be used as an approximate value of the diameter of the first region A1.

S_{aH}=π(D/2)² (3)

When the second conductive layer 33 has a plurality (n) of layers of conductive materials (the first metal layer 34 and second metal layer 35 illustrated in FIG. 4, for example), since the plurality of layers of conductive materials are connected in series, the electric resistance of the first region A1 is the sum of individual resistances, the sum being a series resistance. Therefore, the resistivity pH of the first region A1 is given by equation (4) below.

$${ρ}_{H} = {\sum }_{i = 1}^{n} {ρ}_{i} \qquad ( 4 )$$

In equation (4), the resistivity pi is the resistivity of an i-th layer when the layers are sequentially numbered from the bottom layer (on the same side as the conductor-exposed portion 13) toward the top layer.

The electric resistance r_{b} of the second region A2 is calculated on the basis of the illustration in FIG. 8B. FIG. 8B illustrates an example of the second region A2 in this embodiment. As illustrated in FIG. 8B, the second region A2 includes the low-conductivity region A2-1 and high-conductivity region A2-2. The low-conductivity region A2-1 and high-conductivity region A2-2 are, for example, cylindrical. The upper surface and lower surface of the high-conductivity region A2-2 are respectively consecutive to the upper surface and lower surface of the low-conductivity region A2-1. The outer circumferential surface of the high-conductivity region A2-2 is in contact with the inner surface of the low-conductivity region A2-1.

In the low-conductivity region A2-1, the length L_{b} is equivalent to the thickness of the first conductive layer 32, and the area S_{bL} is equivalent to the area of the lower surface of the low-conductivity region A2-1, as illustrated in FIG. 8B. The length L_{b} is common to the low-conductivity region A2-1 and high-conductivity region A2-2. In the high-conductivity region A2-2, the area S_{bH} is equivalent to the area of the lower surface of the high-conductivity region A2-2. Since the low-conductivity region A2-1 and high-conductivity region A2-2 are connected in parallel, the electric resistance r_{b} is the reciprocal of the sum of the reciprocals of individual resistances, the reciprocal of the sum being a parallel resistance. Therefore, the electric resistance r_{b} is given by equation (5) below, in which the length L_{b}, the area S_{bL}, the resistivity ρ_{L} of the first conductive layer 32, the area S_{bH}, and the resistivity pH of the second conductive layer 33 are used.

$${r}_{b} = 1 / ( \frac{{S}_{b L}}{{ρ}_{L} {L}_{b}} + \frac{{S}_{b H}}{{ρ}_{II} {L}_{b}} ) \qquad ( 5 )$$

When, the low-conductivity region A2-1 and high-conductivity region A2-2 are shaped like a cylinder and has a thickness adequately smaller than the inner diameter of the cylinder, the areas S_{bL} and S_{bH} in equation (5) are approximately respectively given by equations (6) and (7) below.

S_{bL}≈πDW_{L} (6)

S_{bH}≈πDW_{H} (7)

In equations (6) and (7), D is the diameter of the opening 18, WL is the thickness of the low-conductivity region A2-1, and W_{H} is the thickness of the high-conductivity region A2-2.

When the second conductive layer 33 has a plurality (n) of layers of conductive materials, since the plurality of layers of conductive materials are connected in parallel, the electric resistance of the high-conductivity region A2-2 is the reciprocal of the sum of the reciprocals of individual resistances, the reciprocal of the sum being a parallel resistance. Therefore, the resistivity pH of the high-conductivity region A2-2 is given by equation (8) below.

$${ρ}_{H} = 1 / {\sum }_{i = 1}^{n} \frac{1}{{ρ}_{i}} \qquad ( 8 )$$

In equation (8), the resistivity pi is the resistivity of an i-th layer when the layers are sequentially numbered from the innermost layer (on the same side as the first conductive layer 32) toward the outermost layer.

The surface area and volume of the third region A3 are significantly larger than the surface areas and volumes of the first region A1 and second region A2 described above. Therefore, the electric resistance r_{c} of the third region A3 is significantly lower than the electric resistance rₐ of the first region A1 and the electric resistance r_{b} of the second region A2. Accordingly, the electric resistance r_{c} is ignored in the calculation of the terminal resistance of the terminal conductive layer 31. A portion equivalent to the upper surface of the second region A2 is part of the second conductive layer 33. This part of the second conductive layer 33 is cylindrical. The upper surface of the part of the second conductive layer 33, the part being equivalent to the upper surface of the second region A2, is present on the same plane as the upper surface of the second conductive layer 33 in the third region A3. Similarly, the lower surface of the part of the second conductive layer 33 is present on the same plane as the lower surface of the second conductive layer 33 in the third region A3. The resistance of this part occupies only a slight ratio of the entire resistance of the second region A2. Therefore, the resistance of this part is ignored in the calculation of the terminal resistance of the terminal conductive layer 31.

The resistivity of the insulating coating 12 is significantly higher than the resistivity of the terminal conductive layer 31. Therefore, the electric resistance of the insulating coating 12 is ignored in the calculation of the terminal resistance of the terminal conductive layer 31. That is, the first region A1, second region A2, and third region A3 are part of the terminal conductive layer 31 and do not include the insulating coating 12.

Thus, the terminal resistance r of the terminal conductive layer 31 is given by equation (9) below, in which the electric resistance rₐ of the first region A1 and the electric resistance r_{b} of the second region A2, which have been described above, are used.

$$r = {r}_{a} + {r}_{b} = {L}_{a} / ( \frac{{ρ}_{H}}{{S}_{aII}} ) + \frac{1}{{L}_{b}} / ( \frac{{S}_{b L}}{{ρ}_{L}} + \frac{{S}_{b H}}{{ρ}_{II}} ) \qquad ( 9 )$$

Although not illustrated, the terminal resistance of the terminal conductive layer 41 is also calculated according to a similar theory as for the terminal resistance r of the terminal conductive layer 31 described above.

### <Conductive Connection Ratio>

Next, the conductive connection ratio in this embodiment will be described. The conductive connection ratio is the ratio of the area, in contact with the second exposed region 13b, of the second conductive layer 33 to the area of the terminal surface 15a enclosed with the edge of the opening 18 taken as a boundary. As described above, the second exposed region 13b is part of the conductor-exposed portion 13, and the boundary of the second exposed region 13b is defined by the edge of the opening 18. When the region of the insulating coating 12 is not included in the region, of the terminal surface 15a, enclosed with the edge of the opening 18 taken as the boundary, this enclosed region on the terminal surface 15a matches the second exposed region 13b. In the description below, a connection between the first terminal 15 and the terminal conductive layer 31 will be taken as an example for the conductive connection ratio. However, the conductive connection ratio can be similarly defined for a connection between the second terminal 16 and the terminal conductive layer 41. The conductive connection ratio can be applied not only to the inductance element 1 but also to other electronic parts.

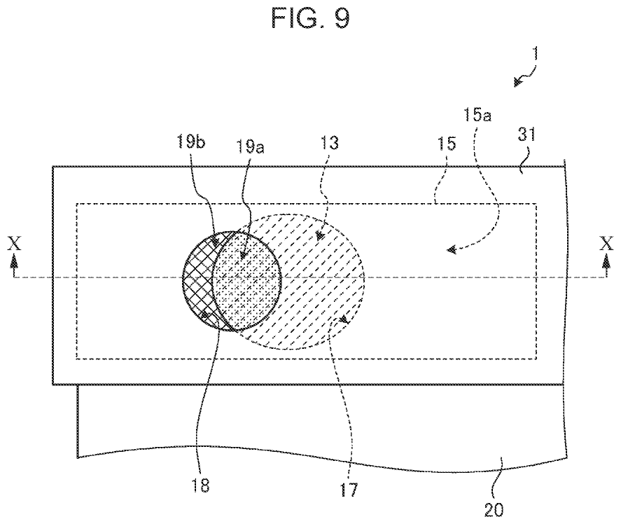

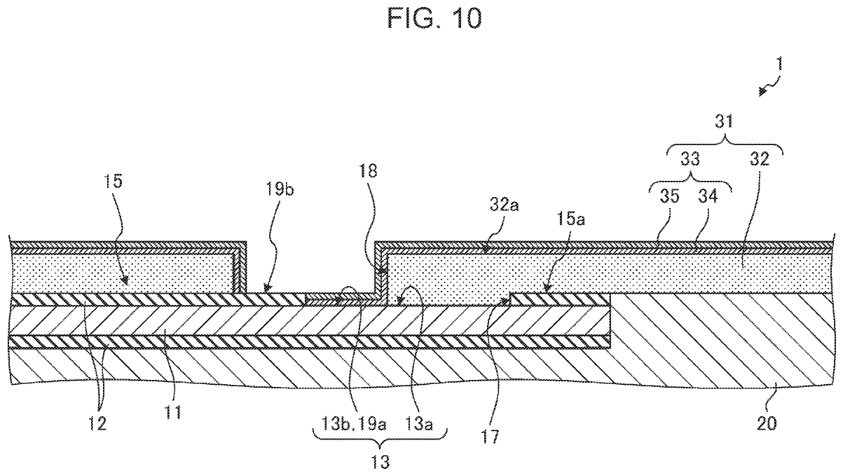

When, for example, part of the region of the insulating coating 12 is included in the area, of the terminal surface 15a, enclosed with the edge of the opening 18 taken as the boundary, the conductive connection ratio is lowered. In this case, part of the edge of the opening 18 is not in contact with the conductor-exposed portion 13. This happens when, for example, the opening 18 is formed at a position different from the target position. FIG. 9 illustrates an example of a positional relationship between the opening 18 and the conductor-exposed portion 13 in the inductance element 1 in this embodiment when part of the edge of the opening 18 is not in contact with the conductor-exposed portion 13. FIG. 10 is a longitudinal sectional view illustrating an example of the cross section of the inductance element 1 in FIG. 9 as taken along line X-X.

As illustrated in FIGS. 9 and 10, the hole 17 is formed in the insulating coating 12 so that the conductor 11 (specifically, the conductor-exposed portion 13) is exposed to the terminal surface 15a. The opening 18 is also formed in the first conductive layer 32 so that the conductor 11 (specifically, the conductor-exposed portion 13) is exposed to the intermediate surface 32a. Part of the opening 18 may deviate to the outside of the hole 17, as illustrated in, for example, FIG. 9. In this case, in the region enclosed by the opening 18, a conductive region 19a and an insulated region 19b are exposed to the topmost surface. In the conductive region 19a, there is an overlap between a region enclosed by the edge of the opening 18 (the region of the opening 18) and a region enclosed by the edge of the hole 17 (the region of the hole 17), as illustrated in FIGS. 9 and 10. The conductive region 19a corresponds to the second exposed region 13b. A region resulting from removing the overlapping region of the opening 18 from the region of the hole 17 corresponds to the first exposed region 13a. The insulated region 19b is a region resulting from removing the overlapping region of the hole 17 from the region of the opening 18. The surface region of the insulating coating 12 includes the insulated region 19b. The insulated region 19b is increased as the conductive region 19a is decreased, and is decreased as the conductive region 19a is increased.

As described above, when the insulated region 19b is present, the first conductive layer 32 comes into contact with the first exposed region 13a without coming into contact with the insulated region 19b. The first metal layer 34 is in contact not only with the upper surface of the first conductive layer 32 and the inner wall surface of the opening 18 but also with the conductive region 19a. The second metal layer 35 is in contact with the upper surface and side surface of the first metal layer 34. That is, the insulated region 19b is not in contact with either of the first conductive layer 32 and second conductive layer 33 but is present on the topmost surface, as illustrated in FIG. 10. As a result, the conductive connection ratio is decreased as the area of the insulated region 19b is increased. The conductive connection ratio is the ratio of the area of the conductive region 19a to the sum of the area of the conductive region 19a and the area of the insulated region 19b. The terminal resistance of the terminal conductive layer 31 is increased as the conductive connection ratio is decreased. When, for example, the conductive connection ratio is 100%, the region of the hole 17 includes the region of the opening 18. In this case, the second exposed region 13b coincides with the region of the opening 18 and is enclosed by the first conductive layer 32 present along the circumferential edge of the hole 17. Under the conditions described above, the second conductive layer 33 is in contact with the second exposed region 13b.

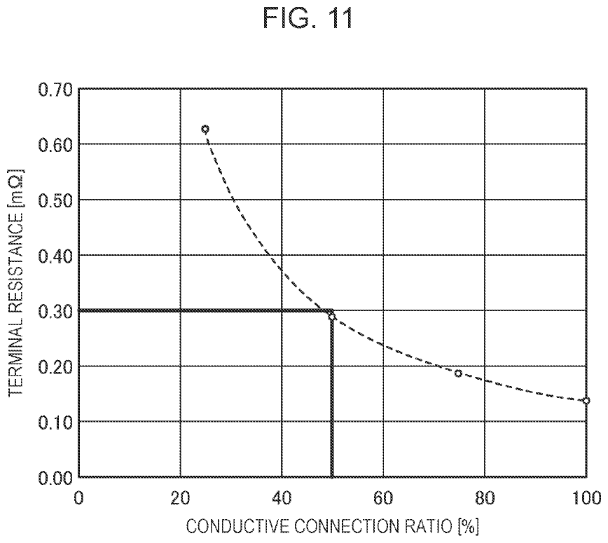

FIG. 11 illustrates an example of a relationship between the conductive connection ratio and terminal resistance of the inductance element 1 in this embodiment. As illustrated in FIG. 11, when the conductive connection ratio is 100%, the terminal resistance is less than 0.14 mΩ. The terminal resistance is inversely proportionally increased as the conductive connection ratio is decreased. When the conductive connection ratio is 25%, the terminal resistance exceeds 0.62 mΩ. The lower limit of the conductive connection ratio f the inductance element 1 can be set according to the terminal resistance demanded for the inductance element 1. When, for example, a terminal resistance of less than 0.30 mΩ is demanded for the inductance element 1, the conductive connection ratio is preferably 50% or more, as illustrated in FIG. 11. That is, the ratio of the area of the conductive region 19a to the sum of the area of the conductive region 19a and the area of the insulated region 19b is preferably 50% or more (in other words, the ratio of the area of the insulated region 19b is 50% or less).

Although not illustrated, in the terminal structure of the inductance element 1, the relationship between the second terminal 16 and the terminal conductive layer 41 is similar to the relationship between the first terminal 15 and terminal conductive layer 31 described above. Therefore, the relationship between the terminal structure and the conductive connection ratio and the relationship between the conductive connection ratio and the terminal resistance for the second terminal 16 and terminal conductive layer 41 are also similar to these relationships for the first terminal 15 and terminal conductive layer 31 described above.

### <Amount of Reduction in Terminal Resistance>

Next, an amount by which the terminal resistance is reduced by the terminal structure of the inductance element 1 in this embodiment will be described. In the description below, the terminal conductive layer 31 will be exemplified to explain the amount of reduction in the terminal resistance. However, the description below about the terminal conductive layer 31 also similarly holds for the terminal conductive layer 41.

As illustrated in FIG. 4, the opening 18 is formed in the first conductive layer 32 and the second conductive layer 33 is in contact with the conductor-exposed portion 13 through the opening 18. That is, part of the first conductive layer 32 is replaced with the second conductive layer 33, the resistivity of which is lower than the resistivity of the first conductive layer 32. Thus, the terminal resistance of the terminal conductive layer 31 is lower than when the terminal conductive layer 31 has a terminal structure in which the first conductive layer 32 is in contact with the entire region of the conductor-exposed portion 13.

In the terminal conductive layer 31 described above, the portion at which the first conductive layer 32 is removed on the conductor-exposed portion 13 is in a columnar shape (specifically, a cylindrical shape). The second conductive layer 33 formed in this portion has a bottomed columnar shape (specifically, a bottomed cylindrical shape). In this case, the amount Δr of reduction in the terminal resistance is conceptually represented by equation (10) below. The second conductive layer 33 in a bottomed cylindrical shape is a combination of a cylindrical portion in contact with the inner wall (the side surface of the first conductive layer 32) of the opening 18 and a discoidal portion in contact with the conductor-exposed portion 13. The thickness of the removed portion of the first conductive layer 32 is assumed to be adequately larger than the thickness of the second conductive layer 33.

Δr=ρ_{L}×d_{L}/Sₐ−(ρ_{H}×d_{H}/Sₐ+ρ_{H}×d_{L}/S_{b}) (10)

In equation (10), ρ_{L} refers to the resistivity of the first conductive layer 32, d_{L} refers to the thickness of the removed portion of the first conductive layer 32, Sₐ refers to the area of the bottom surface of the removed portion of the first conductive layer 32, ρ_{H} refers to the resistivity of the second conductive layer 33, d_{H} refers to the thickness of the second conductive layer 33, and S_{b} refers to the transverse cross section of the cylindrical portion of the second conductive layer 33.

Since the thickness of the first conductive layer 32 is adequately larger than the thickness of the second conductive layer 33, equation (10) above can be approximated to equation (11) below.

Δr=ρ_{L}×d_{L}/Sₐ—ρ_{H}×d_{L}/S_{b} (11)

Since the amount Δr, represented by equation (11), of reduction in the terminal resistance is a positive value (Δr>0), equation (11) can be rewritten as equation (12).

4×ρ_{L}/−ρ_{H}/d_{H}>0 (12)

In equation (12), D refers to the diameter of the bottom surface of the removed portion of the first conductive layer 32. Equation (12) can be rewritten as equation (13) below.

D<4×ρ_{L}×d_{H}/ρ_{H} (13)

For example, the resistivity ρ_{L} of the first conductive layer 32 is 2.0×10⁻⁶ [Ωm], the resistivity ρ_{H} of the second conductive layer 33 is 1.0×10⁻⁷ [Ωm], and the thickness d_{H} of the second conductive layer 33 is 1.0×10⁻⁵ [m]. In this case, according to equation (13), the diameter D of the bottom surface of the removed portion of the first conductive layer 32 is 8.0×10⁻⁴ [m] or less. That is, to increase the amount Δr of reduction in the terminal resistance, the diameter D is preferably 8.0×10⁻⁴ [m] or less. The diameter D is equivalent to the diameter of the opening 18 formed in the first conductive layer 32.

When a metal-plated layer is formed in the opening 18 as the second conductive layer 33, the diameter D is preferably 5.0×10⁻⁵ [m] or more to stably form the metal-plated layer. When the second conductive layer 33 occupies 50% of the entire region of the inner wall of the opening 18, the upper limit of the diameter D is 50%. Therefore, to more reliably reduce the terminal resistance even if part of the conductive path of the second conductive layer 33 is discontinued, the diameter D is preferably 4.0×10⁻⁴ [m] or less.

### <Method of Manufacturing the Electronic Part>

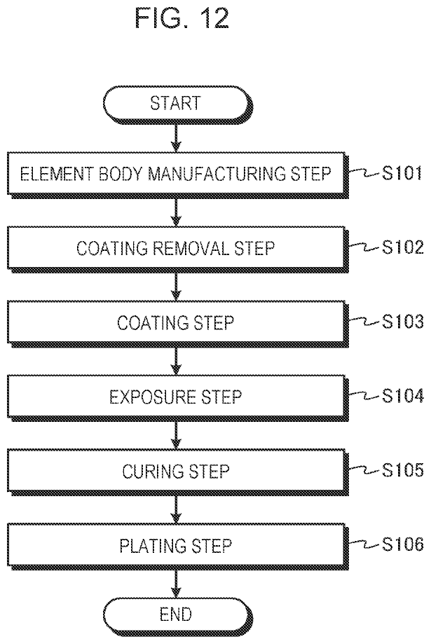

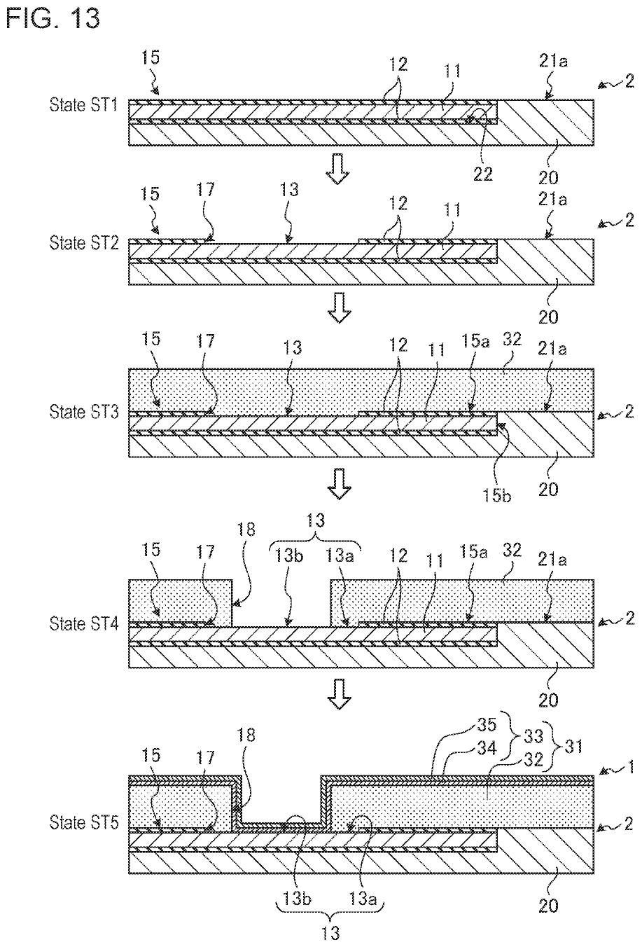

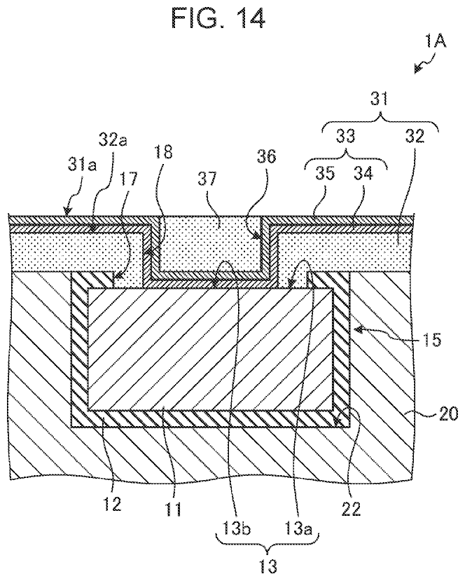

Next, a method, in an embodiment of the present invention, of manufacturing an electronic part will be described in detail with the inductance element 1 described above taken as an example. FIG. 12 is a flowchart illustrating a method, in this embodiment, of manufacturing the inductance element 1. FIG. 13 illustrates longitudinal cross sections indicating a specific example of the method, in this embodiment, of manufacturing the inductance element 1. The inductance element 1 (see FIGS. 1 to 5) can be manufactured by sequentially performing the steps in FIG. 12. In the description below, when the second terminal 16 and terminal conductive layer 41 can be explained by reading the first terminal 15 and terminal conductive layer 31 as respectively referring to the second terminal 16 and terminal conductive layer 41, the explanation of the second terminal 16 and terminal conductive layer 41 may be omitted.

Specifically, the method of manufacturing the inductance element 1 begins with manufacturing an element body 2 of the inductance element 1 (step S101 called an element body manufacturing step), as illustrated in FIG. 12. This element body 2 is such that the first terminal 15 and second terminal 16 of the coil 10 are exposed to the topmost surface and the ring-shaped portion 101 of the coil 10 is embedded in the magnetic core 20.

In step S101, as illustrated in FIG. 1, the ring-shaped portion 101 is formed by winding a band-shaped body, after which both ends of the band-shaped body are bent to form the first terminal 15 and second terminal 16. Then, the coil 10 is placed in a cavity of a mold and then materials (specifically, magnetic powder and a binder) of the magnetic core 20 are supplied into the cavity, after which the mold is heated while a predetermined pressure is applied to the mold. Thus, the magnetic core 20 including the ring-shaped portion 101 is formed. This completes the manufacturing of the element body 2 having the coil 10 and magnetic core 20.

Magnetic powder in the magnetic core 20 is, for example, soft magnetic alloy powder. An example of this type of soft magnetic alloy powder is powder of a Fe-based amorphous alloy. The main element of the Fe-based amorphous alloy is Fe (50 atomic percent or more, for example). To easily form an amorphous layer and power and to make the Fe-based amorphous alloy resistant to corrosion, the Fe-based amorphous alloy may include Ni, Sn, Cr, P, C, B, and Si. For example, the Fe-based amorphous alloy is composed of at least one selected from Ni, Sn, Cr, P, C, B, and Si as well as a remainder composed of Fe and an impurity. The total weight of Ni, Sn, Cr, P, C, B, and Si is, for example, 50% or less. Magnetic powder can be manufactured from molten steel by a water atomization method. The binder in the magnetic core 20 is, for example, an acrylic resin, a silicone resin, or an epoxy resin.

The first terminal 15 is fitted into the recess 22 formed in the lower surface 21a of the magnetic core 20 and is exposed to the lower surface 21a, as illustrated in state ST1 in FIG. 13. In this state, the conductor-exposed portion 13 has yet to be formed in the first terminal 15. Although not illustrated, the second terminal 16 is also fitted into the recess 23 formed in the lower surface 21a of the magnetic core 20 and is exposed to the lower surface 21a. The conductor-exposed portion 14 has yet to be formed in the second terminal 16 as well.

After step S101, part of the insulating coating 12 is removed from the element body 2 (step S102 called a coating removal step). In step S102, part of the insulating coating 12 is removed from the first terminal 15 to form the hole 17 in the insulating coating 12, as illustrated in state ST2 in FIG. 13. Thus, part (specifically, the conductor-exposed portion 13) of the conductor 11 is exposed to the lower surface 21a of the magnetic core 20 through the hole 17. As for the second terminal 16, a hole is also formed in the insulating coating 12, and the conductor-exposed portion 14 is exposed to the lower surface 21a through the hole, similarly as with the first terminal 15.

After step S102, the first conductive layer 32, which is a coated layer, is formed on the first terminal 15 (step S103 called a coating step). In step S103, a conductive paste including a resin and particles of a conductive material is applied to the surface of the magnetic core 20 and the surfaces of the first terminal 15 and second terminal 16. Specifically, the conductive paste is applied to the first terminal 15 and second terminal 16 with a predetermined spacing between them in the width direction of the magnetic core 20 so as to cover the surfaces of the first terminal 15 and second terminal 16. The conductive paste is applied to the boundary (specifically, the edge of the end surface 15b) between the terminal surface 15a and the lower surface 21a of the magnetic core 20, and is also applied so as to pass over the edge of the hole 17. Thus, the first conductive layer 32, which covers the lower surface 21a of the magnetic core 20 and the surface of the first terminal 15, is formed as illustrated in, for example, state ST3 in FIG. 13. In this state, the first conductive layer 32 is in contact with the entire region of the conductor-exposed portion 13 through the hole 17. As for the second terminal 16, a first conductive layer formed from a conductive paste is also formed as with the first terminal 15.

After step S103, part of the first conductive layer 32 is removed from the terminal surface 15a (step S104 called an exposure step). In step S104, the opening 18 is formed in the first conductive layer 32 so that the conductor-exposed portion 13 is exposed to the terminal surface 15a through the opening 18. In this case, the first conductive layer 32 (specifically, a region of the first conductive layer 32, the region covering the conductor-exposed portion 13) is removed from the surface of the conductor-exposed portion 13 to form the opening 18, as illustrated in, for example, state ST4 in FIG. 13. Thus, the first exposed region 13a comes into contact with the first conductive layer 32 and the second exposed region 13b is exposed to the terminal surface 15a through the opening 18. In the second terminal 16 as well, an opening is formed in the first conductive layer, and the second exposed region is exposed to the terminal surface 16a through this opening, similarly as with the first terminal 15. In this case, the first exposed region of the conductor-exposed portion 14 and its relevant first conductive layer are in contact with each other. The opening 18 is preferably formed so that the edge of the opening 18 does not include the edge of the conductor-exposed portion 13. That is, the edge of the opening 18 is preferably distant from the edge of the conductor-exposed portion 13 toward the inside. In this case, the insulating coating 12 is not present on the edge of the opening 18. Since it is difficult to form the second conductive layer 33 on the insulating coating 12, defects of the second conductive layer 33 can be reduced in step S106, which will be described later, making it possible to prevent terminal resistance from being increased.

After step S104, the binder in the first conductive layer 32 is cured (step S105 called a curing step). In step S105, the first conductive layer 32 is heated to, for example, the curing temperature of the binder. Thus, the first conductive layer (specifically, the first conductive layer 32 illustrated in, for example, state ST4 in FIG. 13) is cured. In this curing, a method matching the binder (a method in which heat is used, for example) can be used.

After step S105, the second conductive layer 33 is formed on the surfaces of the first conductive layer 32 and conductor-exposed portion 13 (step S106 called a plating step). The second conductive layer 33 is, for example, a metal layer. The second conductive layer 33 has a lower specific resistance than the first conductive layer 32. The metal layer can be formed by electrolytic plating or non-electrolytic plating. In this case, the metal layer is a metal-plated layer.

Specifically, the first metal layer 34 is formed on the upper surface of the first conductive layer 32, the inner wall of the opening 18, and the second exposed region 13b, as illustrated in state ST5 in FIG. 13. Then, the second metal layer 35 is formed on the upper surface and side surface of the first metal layer 34. Thus, the second conductive layer 33 having a multilayer structure composed of the first metal layer 34 (lower layer) and second metal layer 35 (upper layer) is formed. The second conductive layer 33 is in contact with the first conductive layer 32 and second exposed region 13b. The first conductive layer 32 and second conductive layer 33 constitute the terminal conductive layer 31. Similarly as with the first conductive layer 32 and conductor-exposed portion 13 of the first terminal 15, the second conductive layer is concurrently formed as for the first conductive layer and conductor-exposed portion 14 of the second terminal 16 as well. This second conductive layer also has a multilayer structure composed of a first metal layer and a second metal layer. This second conductive layer is in contact with the first conductive layer of the terminal conductive layer 41 and the second exposed region of the conductor-exposed portion 14. This completes the manufacturing of the inductance element 1.

As described above, the electronic part in the above embodiment has: a conductive unit that has a terminal including a conductor-exposed portion; an insulating unit in contact with the conductive unit, the insulating unit enclosing part of the conductive unit; and a terminal conductive layer in contact with the insulating unit and conductor-exposed portion. The conductive unit is an electricity-conducting body. The insulating unit includes an electric insulator. The conductor-exposed portion is part of the surface of the conductive unit. The terminal conductive layer has: a first conductive layer including conductive particles and a resin; and a second conductive layer formed from a metal having a lower specific resistance than the first conductive layer, the second conductive layer being in contact with the first conductive layer. The first conductive layer and second conductive layer are in contact with the conductor-exposed portion.

Thus, the electric resistance of the terminal conductive layer (that is, terminal resistance), which is electrically connected to a terminal of the conductive unit, can be made lower than the electric resistance of a terminal conductive layer formed from a conductive paste. That is, an electric part having a low terminal resistance can be provided. This makes it possible to reduce the amount of electric power consumed by the electronic part and the amount of heat generated by it. As a result, the energy consumption of the electronic part can be further reduced and thermal design of the electronic part can be further eased. When this type of electronic part is mounted in an electronic unit, its power consumption can be reduced its design range can be widened.

In the above embodiment, the insulating unit has a second edge (specifically, an inner edge) enclosed by the insulating unit. The first conductive layer is in contact with the conductor-exposed portion and second edge along the whole of a closed line drawn by the second edge. Due to this contact, a contact area is expanded between the conductor-exposed portion of the terminal and the second conductive layer having a lower specific resistance than the first conductive layer. This can further reduce the terminal resistance of the terminal conductive layer. Therefore, an electronic part having a further lower terminal resistance can be stably provided.

In the above embodiment, an area over which the second conductive layer is in contact with the conductor-exposed portion is larger than an area over which the second conductive layer is in contact with the first edge of the first conductive layer. Therefore, it is possible to shorten the length of the second conductive layer formed on the side surface, which is the first edge, of the first conductive layer and to increase the contact region (contact area) between the second conductive layer and the conductor-exposed portion. This enables the terminal resistance of the terminal conductive layer to be further reduced. In particular, the area over which the second conductive layer is in contact with the conductor-exposed portion is preferably larger than the area over which the second conductive layer is in contact with the first edge.

In the above embodiment, since the first conductive layer includes a resin, the first conductive layer can be strongly brought into intimate contact with the surface of the insulating unit. To achieve this intimate contact, the surface of the insulating unit preferably includes a resin. In addition, since the first conductive layer includes conductive particles, the second conductive layer can be strongly brought into intimate contact with the first conductive layer. Since the second conductive layer is formed from a metal, the second conductive layer is less likely to be brought into intimate contact with the insulating unit. The first conductive layer is brought into intimate contact with both the insulating unit and the conductor and, as an electricity-conducting body, servers as a bridge between them. The first conductive layer is also brought into intimate contact with both the insulating unit and the second conductive layer and servers as a mechanical bridge between them.

The method, in the above embodiment, of manufacturing an electronic part includes: a coating step of forming a first conductive layer by applying a conductive paste including conductive particles and a resin to the surface of an electricity-conducting body and to the surface of an electric insulator so as to connect the electricity-conducting body and electric insulator together; an exposure step of forming an opening in the first conductive layer so as to expose the electricity-conducting body to a surface; a curing step of curing the first conductive layer; and a plating step of forming a second conductive layer by plating the electricity-conducting body and the first conductive layer with a metal having a lower specific resistance than the first conductive layer so as to connect the electricity-conducting body and first conductive layer together through the opening. Thus, an electronic part, exemplified by the inductance element 1, that has a small terminal resistance can be manufactured.

### <Variation 1>

Next, variation 1 of the electronic part in the above embodiment will be described by using an example in which the electronic part is an inductance element. FIG. 14 is a longitudinal sectional view illustrating an example of an inductance element in variation 1. As illustrated in FIG. 14, the terminal conductive layer 31 in the inductance element 1A in variation 1 has a conductive filler 37 in a recess 36 in the terminal conductive layer 31. Although not illustrated, in the inductance element 1A, the terminal conductive layer 41 also has the conductive filler 37 in a recess in the terminal conductive layer 41.

Specifically, the second exposed region 13b and the upper surface and side surface of the first conductive layer 32 form a recess, as illustrated in FIG. 14. The second conductive layer 33 is in contact with the entire surfaces of this recess. The second conductive layer 33 serves as a bridge between the first conductive layer 32 and the second exposed region 13b. Therefore, the second conductive layer 33 itself also forms the recess 36. Part or the whole of the recess 36 is filled with the conductive filler 37. The conductive filler 37 is made of, for example, the same material as the material, which is a conductive paste, of the first conductive layer 32. The conductive filler 37 is cured by, for example, being heated. Although not illustrated, a recess is also formed in the second conductive layer of the terminal conductive layer 41. Part or the whole of this recess is filled with the conductive filler 37.

As described above, in variation 1, the recess 36 in the second conductive layer 33 is filled with the conductive filler 37. Therefore, the terminal resistance of the electronic part is further reduced and the surface of the terminal conductive layer 31 is further flattened.

### <Variation 2>

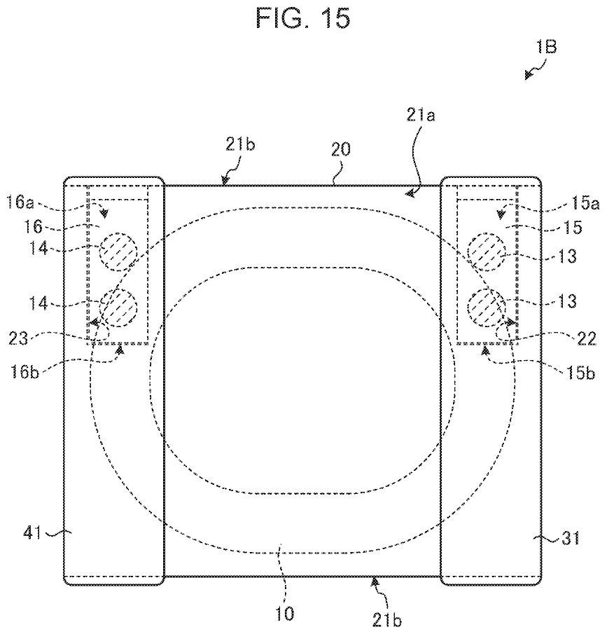

Next, variation 2 of the electronic part in the above embodiment will be described by using an example in which the electronic part is an inductance element. FIG. 15 is a bottom view illustrating an inductance element in variation 2. As illustrated in FIG. 15, the first terminal 15 in the inductance element 1B in variation 2 has a plurality of conductor-exposed portions 13. Similarly, the second terminal 16 has a plurality of conductor-exposed portions 14.

Specifically, a plurality of conductor-exposed portions 13 (in variation 2, two conductor-exposed portions 13) are formed in the first terminal 15, as illustrated in FIG. 15. The terminal conductive layer 31 is in contact with the plurality of conductor-exposed portions 13, so the terminal conductive layer 31 is electrically connected to the first terminal 15. Similarly, a plurality of conductor-exposed portions 14 (in variation 2, two conductor-exposed portions 14) are formed in the second terminal 16. The terminal conductive layer 41 is in contact with the plurality of conductor-exposed portions 14, so the terminal conductive layer 41 is electrically connected to the second terminal 16. The number of conductor-exposed portions 13 and the number of conductor-exposed portions 14 are not limited to 2. These numbers may be 3 or more.

As described above, in variation 2, the first terminal 15 has a plurality of conductor-exposed portions 13, which are electrically connected to the terminal conductive layer 31. Similarly, the second terminal 16 has a plurality of conductor-exposed portions 14, which are electrically connected to the terminal conductive layer 41. Both a region in which the first terminal 15 and terminal conductive layer 31 are brought into electric contact with each other and a region in which the second terminal 16 and terminal conductive layer 41 are brought into electric contact with each other are expanded. Thus, the terminal resistance of the electronic part can be further reduced.

### <Variation 3>

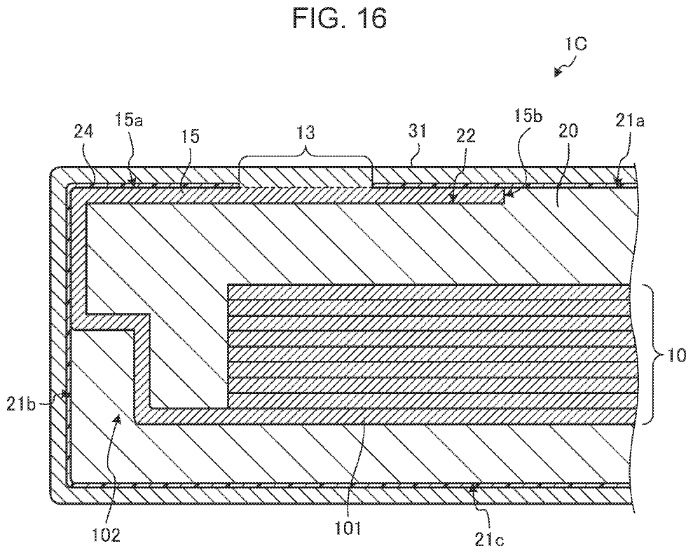

Next, variation 3 of the electronic part in the above embodiment will be described by using an example in which the electronic part is an inductance element. FIG. 16 is a longitudinal sectional view illustrating an inductance element in variation 3. As illustrated in FIG. 16, the inductance element 1C in variation 3 has a covering resin layer 24 on the surfaces of the magnetic core 20. The covering resin layer 24 is an example of an insulating unit in variation 3.

The covering resin layer 24 is formed so as to cover the whole of the lower surface 21a, side surfaces 21b, and upper surface 21c of the magnetic core 20, as illustrated in FIG. 16. The covering resin layer 24 covers the connection portions 102 and 103 as well as the first terminal 15 and second terminal 16 (which are not illustrated in FIG. 16), but does not cover the conductor-exposed portions 13 and 14. That is, the covering resin layer 24 are in contact with the whole of the outer surfaces of a structure composed of the coil 10 and magnetic core 20, except the conductor-exposed portions 13 and 14. A hole communicating with the conductor-exposed portion 13 and a hole communicating with the conductor-exposed portion 14 are formed in the covering resin layer 24. That is, the covering resin layer 24 has inner edges, each of which is enclosed by the covering resin layer 24. Spaces, each of which is enclosed by one of these inner edges, are in contact with the conductor-exposed portions 13 and 14. Although the covering resin layer 24 is present between the terminal conductive layer 31 and the surfaces of the magnetic core 20 and between the terminal conductive layer 41 and the surfaces of the magnetic core 20, due to these holes, an electrical connection is maintained between the conductor-exposed portion 13 and the terminal conductive layer 31 and between the conductor-exposed portion 14 and the terminal conductive layer 41.

The covering resin layer 24 includes an insulative resin. This resin is, for example, a polyimide resin, an epoxy resin, a polyetherimide resin, a polyamide resin, a phenoxy resin, an acrylic resin, a polycarbodiimide resin, a fluorocarbon resin, a polyurethane resin, a polyamide-imide resin, a polyester resin, a polyethersulfone resin, or a combination (modified resin) of two or more of these resins. In particular, this resin preferably has high heat resistance. When the resin is highly resistant to heat, it is possible to increase the heat resistant of the electronic part and to prevent strength from being lowered during heat treatment. Examples of resin having high heat resistance include an epoxy-modified silicone resin, a phenol-modified alkyd resin, a silicone-modified polyester resin, a polyamide-imide-modified epoxy resin, and a polyethersulfone resin. The above resin preferably has low viscosity. When the viscosity of the resin is low, if the surface of the magnetic core 20 is rough, it is possible to fill recesses and defects in the surface with a resin by impregnation. Therefore, the covering resin layer 24 increases the strength of the electronic part.

The magnetic core 20 may be annealed at a high temperature to eliminate distortion of the magnetic material. In this case, the resin in the magnetic core 20 may become vulnerable due to thermal cracking. In particular, the surface of the magnetic core 20 is likely to become vulnerable. The covering resin layer 24 increases the strength of this vulnerable surface. The covering resin layer 24 can also reduce defects in the vicinity of the surfaces of the magnetic core 20, so it is possible to prevent excessive stress and distortion from being applied to the magnetic core 20 due to a temperature change. Thus, the strength and magnetic property of the magnetic core 20 can be stabilized against a temperature change. Since the covering resin layer 24 is present between the terminal conductive layer 31 and the surfaces of the magnetic core 20 and between the terminal conductive layer 41 and the surfaces of the magnetic core 20, as illustrated in, for example, FIG. 16, it is also possible to enhance an intimate contact between the terminal conductive layer 31 and the surfaces of the magnetic core 20 and between the terminal conductive layer 41 and the surfaces of the magnetic core 20.

As described above, in variation 3, the covering resin layer 24 is formed on the surfaces of the magnetic core 20 so as to be present between the terminal conductive layer 31 and the surfaces of the magnetic core 20 and between the terminal conductive layer 41 and the surfaces of the magnetic core 20. Therefore, even if the magnetic core 20 is annealed at a high temperature, the strength of the magnetic core 20 and the property of its surface can be maintained. Basically, metal plating is not performed on the covering resin layer 24. When metal-plated layers are formed as the terminal conductive layers 31 and 41, therefore, the regions of the metal-plated layers can be limited due to the covering resin layer 24. This can prevent a metal-plated layer from being unintentionally formed in a region other than the first conductive layer 32, which is a coated layer of a conductive paste, and conductor-exposed portions 13 and 14. As a result, it is possible to prevent the terminal conductive layers 31 and 41 from being short-circuited due to a metal-plated layer that would otherwise be formed.

When the covering resin layer 24 is not formed on the surfaces of the magnetic core 20 as exemplified by the inductance element 1 in the embodiment described above, it is possible to eliminate extra work needed to form the covering resin layer 24 and remove (clean) it and to easily dissipate heat from the magnetic core 20.

In the embodiments and variations 1 to 3 described above, the terminal conductive layers 31 and 41 have been formed over the lower surface 21a, side surfaces 21b, and upper surface 21c of the magnetic core 20. However, this is not a limitation on the present invention. For example, the terminal conductive layers 31 and 41 may be formed only on the lower surface 21a of the magnetic core 20.

In the embodiments and variations 1 to 3 described above, the conductor-exposed portions 13 and 14 have been formed in a circular shape in plan view. However, this is not a limitation on the present invention. For example, the conductor-exposed portions 13 and 14 may have an elliptical shape, a rectangular shape, or the like in plan view.

In the embodiments and variations 1 to 3 described above, the coil 10 in which the first terminal 15 and second terminal 16 are each integrated with the ring-shaped portion 101 has been exemplified. However, this is not a limitation on the present invention. For example, the coil 10, first terminal 15, and second terminal 16 may be each a separate part. These separate parts may be electrically connected by welding or through a conductive member.

In the embodiments and variations 1 to 3 described above, a metal layer structured with two layers made of different materials (for example, the first metal layer 34 and second metal layer 35) has been exemplified as a metal layer (for example, the second conductive layer 33). However, this is not a limitation on the present invention. For example, the terminal conductive layers 31 and 41 each may a single metal layer or a metal layer having a multilayer structure including three or more layers.

In the embodiments and variations 1 to 3 described above, part of a coated layer of a conductive paste has been removed to expose the second exposed region to a surface in the exposure step (step S104). However, this is not a limitation on the present invention. For example, a mask may be used to expose the second exposed region later. In this case, after a mask has been formed in the second exposed region, a conductive paste is applied in the coating step (step S103). Due to this, the conductive paste is not applied to the second exposed region. Then, the mask is removed in the exposure step (step S104). As a result, an opening is formed in the coated layer, enabling the second exposed region to be exposed to the surface through this opening.

In the embodiments and variations 1 to 3 described above, the element body 2 has been manufactured without an opening communicating with the conductor-exposed portion being formed in the insulating coating 12 in the element body manufacturing step (step S101). However, this is not a limitation on the present invention. For example, in the element body manufacturing step (step S101), the element body 2 may be manufactured from a band-shaped body in which a hole has been formed in the insulating coating 12 in advance so as to communicate with the conductor-exposed portion. In this case, the coating removal step (step S102) may be omitted.

In the embodiments and variations 1 to 3 described above, a sliver paste has been exemplified as the conductive paste. However, this is not a limitation on the present invention. For example, the conductive paste described above may be a copper paste or another conductive paste (other than a sliver paste and a copper paste). The above conductive paste may have a higher specific resistance than a sliver paste, or may be at a lower cost than a sliver paste.

In the embodiments and variations 1 to 3 described above, a case has been exemplified in which the electronic part is an inductance element. However, this is not a limitation on the present invention. For example, the electronic part in the present invention may be a capacitor element or another electronic part other than an inductance element. The functional portion of the conductive unit may be changed to the form of a metal wire, plate electrode, or the like according to the electronic part, without being limited to the ring-shaped portion described above. The insulating unit may be changed to the form of the housing of the above conductive unit or the like according to the electronic part, without being limited to the magnetic core, insulating coating, and covering resin layer described above.

### Example

The present invention will be further specifically described by using an example of the present invention and its comparative example. The present invention should not be construed as being limited to the example and comparative example described below.

### Preparation of Samples

In the preparation of samples, powder of a Fe-based amorphous alloy was first mixed with a resin to obtain a mixture. Then, a coil was embedded in this mixture, after which the resin was cured. In this way, an element body in which a coil is embedded in a magnetic core was prepared similarly as in the element body manufacturing step (step S101). In this preparation, the above coil was formed by using a metal wire resulting from coating the surface of a core wire (conductor) of pure copper with an insulative resin. Both ends of the metal wire were fitted into recesses formed in the lower surface of the magnetic core so as to be exposed from the lower surface to the surface as a pair of terminals.

The surfaces of the pair of terminals described above were irradiated with laser beams to remove part of the resin so that the core wire is exposed to the surface, forming a hole. The shape of the region in which the core wire is exposed to the surface, the region being a conductor-exposed portion, was substantially elliptical in plan view. The center position of the conductor-exposed portion substantially matched the center position of the metal wire in its width direction. Then, similarly as in the coating step (step S103) described above, a conductive paste was applied to the surfaces of the ends of the element body to prevent the pair of terminals from being short-circuited by the conductive paste. A silver paste from Namics Corporation was used as this conductive paste. In this way, ten or more element bodies (referred to below as coated element bodies) to which a silver paste was applied were manufactured.

Then, for the terminals of a half of these coated element bodies, part of the sliver paste was removed to form an opening, through which the core wire was exposed to the surface. The region enclosed by the circumferential edge of the opening, the region being the second exposed region, was circular in plan view. The center position of the second exposed region substantially matched the center position of the metal wire described above in its width direction.

In addition, for all of the coated element bodies described above, a Ni-plated layer was formed on the surface of the silver paste layer and in the second exposed region, after which, for all of the coated element bodies, a Sn-plated layer was formed on the above Ni-plated layer.

Samples in the example and comparative example were prepared as described above. Samples in the example were such that the Ni-plated layer is in contact with both the silver paste layer and the second exposed region. Samples in the comparative example were such that the Ni-plated layer is in contact with only the silver paste layer.

### Evaluation of Resistance

For the samples in the example and comparative example, an evaluation was made for the resistance (specifically, electric resistance) of the terminal conductive layer composed of the silver paste layer and metal-plated layers (Ni-plated layer and Sn-plated layer) described above. Specifically, a conducting wire was connected onto the Sn-plated layer of each sample by soldering, after which the terminal resistance was measured by a four-terminal method. Table 1 indicates evaluation results for the samples.

TABLE 1

| | Resistance [mΩ] | |
|---|---|---|
| | Average resistance | Standard deviation |
| Example | 9.60 | 0.073 |
| Comparative example | 10.52 | 0.493 |

As indicated in Table 1, the average resistance of the samples in the example and the standard deviation of the average resistance (variations in terminal resistance) were smaller than those of the samples in the comparative example. In the example, therefore, the energy efficiency of the inductance element can be increased, that is, energy loss can be reduced. In addition, the inductance element in the example has higher reliability than the inductance element in the comparative example. In the method of manufacturing samples in the example, inductance elements that have high energy efficiency and are highly reliable can be manufactured in stable quality.

The present invention is not limited to the embodiments and variations 1 to 3 described above. The present invention includes products structured by appropriately combining the constituent elements described above and also includes methods of manufacturing these products. The scope of the present invention also includes other embodiments, examples, variations, operation technologies, and the like that are achieved by, for example, a person having ordinary skill in the art according to the embodiments and variations 1 to 3 described above.

1. An electronic part comprising:
a conductive unit including an electrical conductor having a terminal portion, the terminal portion including a conductor-exposed portion provided on a surface of the conductive unit;
an insulating unit including an electrical insulator, the insulating unit being in contact with the conductive unit and covering part of the conductive unit; and
a terminal conductive layer in contact with the insulative unit and the conductor-exposed portion, the terminal conductive layer including:
a first conductive layer including conductive particles and a resin, the first conductive layer having a first resistance; and
a second conductive layer formed of a metal having a second resistance smaller than the first resistance, the second conductive layer being in contact with the first conductive layer,
wherein the first conductive layer and the second conductive layer are both in contact with the conductor-exposed portion.

2. The electronic part according to claim 1,
wherein the first conductive layer has a first opening in a portion where the first conductive layer is in contact with the conductor-exposed portion, such that the second conductive layer is in contact with the conductor-exposed portion through the first opening in the first conductive layer,
and wherein an area over which the second conductive layer is in contact with the conductor-exposed portion is equal to or greater than 50% of an entire area of the conductor-exposed portion.

3. The electronic part according to claim 1,
wherein the insulating unit has a second opening through which the electrical conductor is exposed, thereby providing the conductor-exposed portion,
and wherein the first conductive layer is in contact with the conductor-exposed portion along an entire edge of the second opening.

4. The electronic part according to claim 1,
wherein the first conductive layer has a first opening, while the insulating unit has a second opening,
wherein the first conductive layer is in contact with the conductor-exposed portion through the second opening along an entire edge of the second opening, while the second conductive layer is in contact with the conductor-exposed portion through the first opening along an entire edge of the first opening,
and wherein an area over which the second conductive layer is in contact with the conductor-exposed portion is equal to or greater than 50% of an entire area of the conductor-exposed portion.

5. The electronic part according to claim 1, wherein an area over which the second conductive layer is in contact with the conductor-exposed portion is larger than an area over which the second conductive layer is in contact with an edge of the first conductive layer.

6. The electronic part according to claim 1, wherein the insulating unit has a layer including a resin and in contact with the conductive unit.

7. The electronic part according to claim 3, wherein the insulating unit has a layer formed of a resin and in contact with the conductive unit, the layer having the second opening.

8. The electronic part according to claim 1, wherein the conductive unit is formed of a single metal.

9. The electronic part according to claim 1, wherein the first conductive layer includes such an amount of the conductive particles that a ratio of a cross-sectional area of the conductive particles to a cross-sectional area of the first conductive layer is equal to or greater than 10% and equal to or smaller than 90%.

10. A method of manufacturing an electronic part, comprising:
forming a coating layer by applying a conductive paste including a conductive particle and a resin over a surface of an electrical insulator and a surface of an electrical conductor exposed on a portion of the surface of the electrical insulator;
forming an opening in the coating layer so as to expose the electrical conductor through the opening;
curing the coating layer, thereby forming a first conductive layer having the opening; and
forming a second conductive layer by plating the first conductive layer and the electrical conductor exposed through the opening of the first conductive layer with a metal, such that the second conductive layer is connected to the electrical conductor through the opening and that the first conductive layer is also connected to the electrical conductor around the opening thereof.

11. The method according to claim 10, wherein the metal of the second conductive layer has an electrical resistance smaller than that of the first conductive layer.

12. The electronic part according to claim 1, wherein the insulating unit covers the conductive unit except the conductor-exposed portion where the electrical conductor of the conductive unit is exposed.
